(19) United States
(12) Patent Application Publication
(10) Pub. No.: US 2002/0054764 A1
(43) Pub. Date: May 9, 2002

(54) Automatic aperture control circuit for automatic diaphragm lens of CCTV camera

(75) Inventor: Toru Shikano, Tokyo (JP)

Correspondence Address: GREENBLUM & BERNSTEIN, P.L.C., 1941 ROLAND CLARKE PLACE, RESTON, VA, 20191, US

(73) Assignee: ASAHI SEIMITSU KABUSHIKI KAISHA, Tokyo (JP)

(21) Appl. No.: 09/984,593

(22) Filed: Oct. 30, 2001

(30) Foreign Application Priority Data
Nov. 6, 2000 (JP) 2000-337436

(51) Int. Cl. G03B 17/48

(52) U.S. Cl. 396/429

(57) ABSTRACT

In an automatic aperture control circuit for an automatic diaphragm lens of a CCTV camera, having a ballast power source circuit II which stabilizes an externally supplied power source, an input signal detector III, an output circuit IV, and an intermediate power source circuit V, in which opening and closing operations of a diaphragm is controlled in accordance with a diaphragm drive signal which is obtained from an image signal or a spurious signal, output from a CCTV camera, using an iris servo-meter apparatus VI, a surge prevention device is inserted between the portion of a power line P1 of the ballast power source circuit II on the input side and a ground line, and a low impedance fixed resistor R1 is inserted in series between a connection point of the power line P1 to the surge absorber and the reverse connection prevention diode D1 of the ballast power source II.

### BACKGROUND OF THE INVENTION

1. Field of the Invention

The present invention relates to an automatic aperture control circuit for an automatic diaphragm lens of a CCTV camera.

2. Description of the Related Art

In a conventional automatic diaphragm lens in which a diaphragm drive signal is obtained from an image signal or spurious signal supplied from a CCTV camera, no measures against lightning surge have been taken. Consequently, if lightning surge is applied to a power source line of the CCTV camera, the automatic aperture control circuit is instantaneously broken, thus resulting in the loss of functions of the CCTV camera.

In general, as measures against the surge of the power line in an electronic devices, an element such as a varistor or a surge absorber is provided between a power line and a ground line, so that the surge pulses are supplied to the surge countermeasure element, such as the varistor or the surge absorber to protect circuits of the electronic device. However, in case of the automatic aperture control circuit for a CCTV automatic diaphragm control lens, the power source voltage of the camera to be employed is not constant and, hence, the power source voltage is stabilized by a power source IC or a discrete circuit. Nevertheless, since the impedance of the ballast power circuit is very low, it is difficult to protect the ballast power circuit from the lightning surge only by the insertion of the element such as the varistor or the surge absorber between the power line and the ground lien.

It is an object of the present invention to provide an automatic aperture control circuit for a CCTV automatic diaphragm lens, which can protect the same from the lightning surge.

### SUMMARY OF THE INVENTION

To achieve the object of the present invention, according to the present invention, there is provided an automatic aperture control circuit for an automatic diaphragm lens of a CCTV camera, having a ballast power source circuit which stabilizes an externally supplied power source, in which opening and closing operations of a diaphragm is controlled in accordance with a diaphragm drive signal which is obtained from an image signal or a spurious signal, output from a CCTV camera, wherein a surge prevention device is inserted between the portion of a power line of the ballast power source circuit that is located on the input side and a ground line, and a low impedance resistor is inserted between a connection point of the power line to the surge prevention device and the ballast power source.

With this structure, it is possible to protect the entirety of the automatic aperture control circuit including the ballast power source circuit from the lightning surge.

If a reverse connection prevention diode connected is inserted in series in the power line portion of the ballast power source circuit on the input side, a surge absorber is inserted as the surge prevention device, and the low impedance resistor is inserted between the connection point to the surge absorber and the reverse connection prevention diode or between the reverse connection prevention diode and the power line portion of the ballast power source on the input side.

The reverse connection prevention diode is preferably a Schottky barrier diode.

The resistance of the low impedance resistor is selected to be approximately 3Ω to 10Ω when the input power source voltage of the ballast power source circuit is approximately DC 8V to 15V and the output voltage thereof is approximately 7V.

The present disclosure relates to subject matter contained in Japanese Patent Application No.2000-337436 (filed on Nov. 6, 2000) which is expressly incorporated herein by reference in its entirety.

### BRIEF DESCRIPTION OF THE DRAWINGS

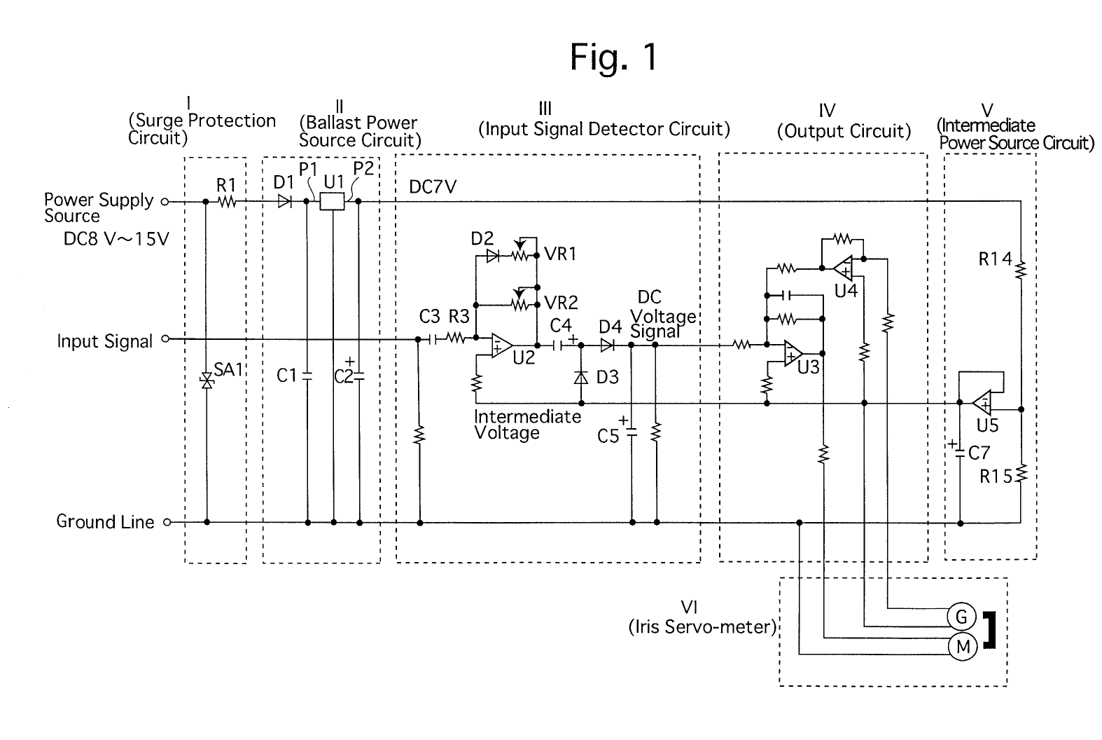

The present invention will be discussed below with reference to the accompanying drawing, of which FIG. 1 is a circuit diagram of an embodiment of an automatic aperture control circuit for an automatic diaphragm lens of a CCTV camera, according to the present invention.

### DESCRIPTION OF THE PREFERRED EMBODIMENT

In FIG. 1, an aperture control circuit 10 is comprised of a surge protection circuit I which is one of the most significant features of the present invention, a ballast power source circuit II, an input signal detector circuit III, an output circuit IV, an intermediate power source V, and an iris servo-meter apparatus VI. Although not shown, the iris servo-meter apparatus VI is, as is well known, provided on a diaphragm apparatus to open and close diaphragm blades by a driving coil (servo-meter or galvano-meter) M.

The ballast power source circuit II is supplied with electricity from a constant voltage power source (not shown) and outputs a constant voltage through a three-terminal regulator U1. The input side of the power line of the ballast power source II, i.e., the power line P1 on the input side of the three-terminal regulator U1 is provided therein with a reverse connection prevention diode D1 connected in series. A regulator input condenser C1 and a regulator output condenser C2 are inserted between the power line P1 on the input side of the three-terminal regulator U1 and the ground line and between the power line P2 on the output side and the ground line, respectively. In the illustrated embodiment, the rated input voltage is in the range of DC 8V to 15V and the rated output voltage is DC 7V, by way of example.

The constant voltage (7V) output from the ballast power source circuit II is divided by a voltage follower circuit having an operational amplifier U5 of the intermediate power source circuit V, condenser C7 and resistors R14 and R15 and is supplied, as a intermediate voltage (circuit operating reference voltage) to the input signal detector circuit III and the output circuit IV.

The input signal detector circuit III receives an input signal, i.e., a diaphragm control image signal output from a TV camera; removes a DC component of the diaphragm control image signal by the condenser C3; and supplies the same to the inversion input terminal of the operational amplifier U2 through the resistor R3. The operational amplifier U2 inverts and amplifies the diaphragm control mage signal input to the inversion input terminal thereof, using the intermediate voltage input to the non-inversion input terminal as a reference voltage. The inverted and amplified diaphragm control image signal is rectified by a voltage doubler comprised of condensers C4, C5, diodes D3, D4, and a resistor R5, and is supplied to the output circuit IV as a smoothed DC voltage signal. Note that the amplification of the operational amplifier U2 is adjusted by adjusting the resistance of the variable resistor VR2 to thereby control the output level thereof. Moreover, the amplification of the operational amplifier U2 on the negative side can be controlled by the diode D2 and the variable resistor VR1, so that the rectification efficiency of the voltage doubler can be varied in accordance with the adjustment of the amplification on the negative side to thereby control the measurement by the photometering operation.

The output circuit IV amplifies the DC voltage signal (diaphragm control mage signal) amplified and rectified by the input signal detector circuit III, using the operational amplifier U3 and produces the diaphragm drive voltage. Consequently, the iris driving coil M of the iris servo-meter apparatus VI is driven in accordance with the diaphragm drive voltage, so that the diaphragm blades are stopped at a position in which the drive force of the iris driving coil M and the biasing force of the diaphragm spring are balanced. In this position, the signal which has been output from the speed control coil G of the iris servo-meter apparatus VI and which has been inverted and amplified by the operational amplifier U4 is fed back to the inversion input terminal of the operational amplifier U3 as a speed feedback signal of the operational amplifier U3 to control the diaphragm operation speed.

The above-mentioned discussion has been addressed to the general structure of the automatic aperture control circuit for an automatic diaphragm lens of a CCTV camera. The surge protection circuit I which is one of the most significant features of the present invention will be discussed below.

In general, the power source voltage to be supplied, of an automatic aperture control circuit for an automatic diaphragm lens of a CCTV camera is in the range of DC 8V to 15V and is determined so that a voltage drop caused by the surge protection circuit at the power source voltage of DC 8V is not below a difference between the input voltage and the output voltage, necessary for the ballast power source circuit.

If the three-terminal regulator U1 is used as the ballast power source circuit II as usual, the voltage difference between the input and output voltages is approximately 2V. However, if a three-terminal regulator having a small voltage difference is used, the voltage difference is approximately 0.48V. If a regulator having an output voltage of approximately DC 7V is used as the ballast power source circuit, the total voltage drop caused by the reverse connection prevention diode D1 and the fixed resistor must be smaller than approximately 0.52V.

To this end, in the illustrated embodiment, a Schottky barrier diode whose voltage in the forward direction is small is used as the reverse connection prevention diode D1, so that the resistance (R1) of the fixed resistor can be set at a high value.

In the illustrated embodiment, the maximum consumptive current of the automatic aperture control circuit is 50 mA and the temperature of use is −20° C. The voltage at −20° C. at which the voltage in the forward direction of the diode D1 within the use temperature is maximum is approximately 0.35V and, hence, the resistance of the fixed resistor R1 is approximately 3.3Ω. Consequently, it is possible to resist the lightning surge voltage applied to the power source up to ±1KV.

In the basic circuit of the surge protection circuit I, the resistance of the fixed resistor R1 is approximately 3.3Ω, when the reverse connection prevention circuit D1 is used. If the reverse connection prevention diode is not used or if the ballast power source voltage is not 7V but is smaller than 7V, e.g., in the range of DC 5V to DC 6V, the difference between the input and output voltages is large enough to increase the resistance of the fixed resistor R1. In this case, the lightning surge resisting voltage can be further increased.

Although the fixed resistor R1 is inserted between the connection point of the power line to the surge absorber SA1 and the reverse connection prevention diode D1 in the illustrated embodiment, it is possible to insert the fixed resistor between the reverse connection prevention diode D1 and the power line P1 of the three-terminal regulator U1 on the input side.

If the reverse connection prevention diode D1 is not used, since the voltage component of 0.35V in the forward direction is replaced with the fixed resistor R1, it is possible to increase the resistance of the fixed resistor R1 to approximately 10Ω. However, if the ballast voltage is reduced, the loss of the regulator U1, at, for example, DC 15V is increased when the supply voltage is high. Consequently, a large regulator IC having a large allowable loss must be used and, hence, it is difficult to provide a large space in a small CCTV automatic diaphragm lens.

As may be seen from the foregoing, as measures against the lightning surge of the power source of the automatic aperture control circuit, whose supply voltage is approximately DC 8V to 15V, it is very useful to combine the surge absorber SA1 and the fixed resistor R1 of approximately 3.3Ω to 10Ω, wherein the ballast power source circuit is set at approximately 7V.

Note that the device to prevent the lightning surge is preferably made of a silicone surge absorber, but the present invention is not limited thereto. The resistance of the fixed resistor R1 can be determined in accordance with the specifications, such as the input and output voltages.

As may be understood from the above discussion, according to the present invention, in a CCTV automatic diaphragm lens, a surge absorber is inserted between the power line on the input side of the ballast power source circuit and the grand line and a low impedance resistor is inserted between the connection point of the surge absorber to the power lien on the input side and the ballast power source circuit, it is possible to protect the entirety of the automatic aperture control circuit including the ballast power source circuit from the lightning surge.

What is claimed is:

1. An automatic aperture control circuit for an automatic diaphragm lens of a CCTV camera, having a ballast power source circuit which stabilizes an externally supplied power source, in which opening and closing operations of a diaphragm is controlled in accordance with a diaphragm drive signal which is obtained from an image signal or a spurious signal, output from a CCTV camera, wherein
a surge prevention device is inserted between the portion of a power line of the ballast power source circuit that is located on the input side and a ground line, and
a low impedance resistor is inserted between a connection point of the power line to the surge prevention device and the ballast power source.

2. An automatic aperture control circuit for an automatic diaphragm lens of a CCTV camera, according to claim 1, wherein said ballast power source circuit is provided with a reverse connection prevention diode connected in series to the power line portion on the input side, said surge prevention device being made of a surge absorber, said low impedance resistor being inserted between the connection point to the surge absorber and the reverse connection prevention diode.

3. An automatic aperture control circuit for an automatic diaphragm lens of a CCTV camera, according to claim 1, wherein said ballast power source circuit is provided with a reverse connection prevention diode connected in series to the power line portion on the input side, said surge prevention device being made of a surge absorber, said low impedance resistor being inserted between the reverse connection prevention diode and the power line portion of the ballast power source on the input side.

4. An automatic aperture control circuit for an automatic diaphragm lens of a CCTV camera, according to claim 2, wherein said reverse connection prevention diode is a Schottky barrier diode.

5. An automatic aperture control circuit for an automatic diaphragm lens of a CCTV camera, according to claim 2, wherein the resistance of the low impedance resistor is in the range of approximately 3Ω to 10Ω when the input power source voltage of the ballast power source circuit is approximately DC 8V to 15V and the output voltage thereof is approximately 7V.
